(19) United States
(12) Patent Application Publication
(10) Pub. No.: US 2022/0100900 A1
(43) Pub. Date: Mar. 31, 2022

(54) MODIFYING DATA ITEMS

(71) Applicant: Hewlett-Packard Development Company, L.P., Spring, TX (US)

(72) Inventors: Adrian John Baldwin, Bristol (GB); Daniel Ellam, Bristol (GB); Nelson L. Chang, Palo Alto, CA (US); Jonathan Griffin, Bristol (GB)

(73) Assignee: Hewlett-Packard Development Company, L.P., Spring, TX (US)

(21) Appl. No.: 17/414,587

(22) PCT Filed: Jun. 14, 2019
(86) PCT No.: PCT/US2019/037281

§ 371 Date: Jun. 16, 2021

(51) Int. Cl. G06F 21/62; G06F 21/60

(52) U.S. Cl. CPC G06F 21/6254; G06F 21/602

(57) ABSTRACT

In examples, there is provided a method for modifying a data item from a source apparatus, the data item associated with an event, in which the method comprises, within a trusted environment, parsing the data item to generate a set of tuples relating to the event and/or associated with the source apparatus, each tuple comprising a data item, and a data identifier related to the data item, applying a rule to a first tuple to pseudonymise a first data item to provide a transformed data item, and/or generate a contextual supplement to the first data item, generating a mapping between the transformed data item and the first data item, whereby to provide a link between the transformed data item and the first data item to enable subsequent resolution of the first data item using the transformed data item, and forwarding the transformed data item and the data identifier related to the first data item to an analytics engine situated logically outside of the trusted environment.

### BACKGROUND

Nodes in a network, whether print devices, PCs or IoT devices and so on, can produce multiple events. The events can relate to processes executing within the nodes, logon attempts and so on. Such events can be used to determine the occurrence of potential security issues within the network, or other issues that may benefit from attention. Such events can include personal or confidential data.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1 is a schematic representation of a system according to an example;

FIG. 2 is a schematic representation of a system according to an example; and

FIG. 3 is a flowchart of a method according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Managing privacy for data collected for analytics can be complex in view of legislation such as GDPR which constrain the use of personal data and sharing with other data processors.

Devices or source apparatus, such as those forming nodes or endpoints in a network, can produce events that are sent to a server or to the cloud where they can be analysed to look for potential attacks, anomalous and/or suspicious behaviours or administrative issues, and inefficient or inadvertent events (the latter potentially leading to a weakened security posture for example). Data between events can be correlated in order to understand the context in which the event occurred such as locations, who was causing the event, the role and tasks that those causing events play within an organization and so on.

Some of the additional information to understand the context of the event may be historical and so correlation can be performed using historical data stores; for example, such as that defining a user's role at the time of the event.

However, events, such as security events or other kinds of device events (including performance related, and other device telemetry, etc. events) generated at devices often contain personal or confidential data. The growth and strengthening of privacy laws means that it can be difficult to store and process personal data particularly given consent for purpose; the right to be forgotten; secure data storage; storing data in the right jurisdiction and so on. In addition, duties can transfer to third party data processors such as a security service provider, and security events may also contain company sensitive information that the company may prefer not to share with third party security services.

Raw events including personal data may not have any contextual data associated with them. Such data is useful in finding security patterns and attacks. In addition, contextual data can be used to blur personal or private data whilst providing a useful security context. For example, a security service may be interested in detecting attack patterns, anomalous and/or suspicious user behaviours or bad patterns of device administration. Contextual information about the users and devices involved, such as their roles within the company and their physical locations and the business unit they represent for example, can be useful for these purposes as they enable application of additional security analytics. For example, event data relating to failed logins to a number of printers including contextual information as to their locations (which site or office they serve, or which business unit they serve for example) can be used to determine whether the failed login activity (perhaps associated with attempts at password guessing) is targeted in a given location/office/business unit. When looking at the source IP for such attempts having contextual information about the network can help; such as was the IP address (or addresses) associated with a VPN or particular office locations or whether the location is in a meeting room.

However, such contextual data may not be contained in the original event data. According to an example, contextual information can be added to event data. The presence of additional contextual data can be used to determine security detection rules to be applied and thus when further security insights can be achieved. For example, several failed logins to printers in which the associated events include contextual information about the location, such as the site they are located at or the business they support, can be used to determine if this activity is targeted at a given location or against a given part of the organization.

From an analytics perspective contextual information, such as that in relation to security events for example, can help in enhancing analytics of such events and their value. In an example, information in event data that is (or may be) considered personal (or enterprise confidential) can be anonymised and/or pseudonymised (e.g. using pseudonymised tokens) and/or replaced or augmented with contextual information. For example, a user name in an event may be pseudonymized, whereas a job name may be anonymized. This can enable analytics to provide insights to an enterprise for example as event data will be actionable, whilst providing privacy for the entities involved. For example, user names can be substituted with a tracking token or GUID (Global Unique Identifier) and information about groups that the user is a member of; assuming the groups are sufficiently large. Furthermore, location information can be blurred from exact locations (or IP addresses) to broader categories such as offices, regions etc. This enables analytics to determine the presence of attacks (or bad administration) on or from particular locations or groups of users for example.

According to an example, there is provided an analytic driven anonymization/pseudonymisation and contextualization framework that supports this process, which can be driven from a choice of analytics and designed to support a third-party security service provider.

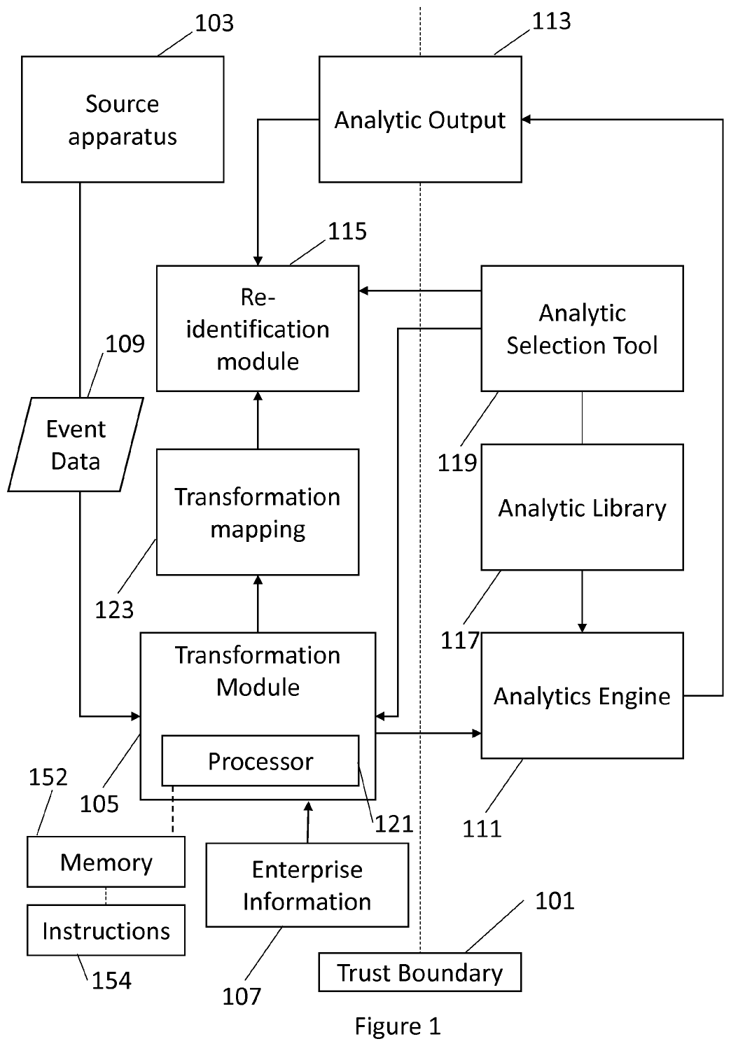

FIG. 1 is a schematic representation of a system according to an example. In the example of FIG. 1, a trust boundary 101 is depicted. The trust boundary 101 defines a logical boundary between a trusted environment within which a source apparatus 103 is located, and a non-trusted environment. The non-trusted environment is that to which personal and/or private data which forms part of an event generated by the source apparatus 103 should not be passed. A source apparatus 103 can be a node or endpoint in a network. For example, a source apparatus 103 can be an IoT device, printer, PC and so on.

In an example, analytics can be generated within one boundary (such as a security service provider in a non-trusted environment to the right of the trust boundary 101 in FIG. 1) whilst personal and confidential information is retained within, for example, an enterprise (i.e. a trusted environment to the left of the trust boundary 101 in FIG. 1).

According to an example, in a set up phase, analytics can be selected, and transformation rules to transform a data item, such as anonymization, pseudonymisation and contextualization rules, can be generated and sent to the transformation module 105. In this phase, a link to an enterprise information system 107 can be made in order to enable the provision of contextual information. Alternatively, contextual information may be provided directly by a client. In an example, a set up phase can be revisited as the set of analytics changes.

In a runtime phase, according to an example, event data 109, such as that representing security event messages for example, are created by devices such as the source apparatus 103 of FIG. 1. The event data 109 is sent to the transformation module 105 which applies one or more rules to transform or modify the data (i.e. by way of one or more of anonymization, pseudonymisation and contextualization rules in order to anonymise, pseudonymise and contextualise the data) before forwarding the messages to the analytics engine 111. The analytics engine 111 can, in an example, provide results in an analytics output module 113, whose results can include link(s) back to a re-identification module 115 so that authorised personnel (or systems) can re-identify pseudonymised entities, conduct further investigation, and take any necessary remediations for example.

According to an example, an analytics library 117 is provided. The analytics library 117 can be used to store one or more sets of analytics rules. Analytics can be augmented with a description of information fields along with the purpose and value of the analytic rule from a security perspective. The description of the information fields can include hint(s) of where to get information (such as an enterprise (active) directory) along with links to adaptors.

An analytics selection tool 119 can optionally be used by a company subscribing to an analytics system to view the library of analytic rules available and the information that should be provided in order to use them. In an example, the data processor/service provider may decide which subset of analytic rules can be used.

In an example, this can be displayed in terms of:
Personal data or anonymization/pseudonymisation options;
Contextual data to be added along with options over the granularity of the contextualization.

For example, this may relate to the location of a device or user and how fine grained the information may be. For example, for location information, this may allow choices for selecting sites or regional locations based on the number of devices/users in an area. This may include example sample data to aid the clients' decision process.

Once selections are made the analytics can be enabled in the analytics engine 111 and transformation (e.g. anonymization, pseudonymisation and contextualization) rules configured within the transformation module 105. Thus, the relationship between 119 and 117 and 105 are concerned with establishing the transformations that should occur and the two sides of the trust boundary operate independently after the rules are established. Transformation rules may go through a review prior to being enacted. In an example, the configuration of the latter can also include specifying the location of enterprise systems containing contextualization data such as the enterprise active directory (if appropriate permissions/authentication exist or can be set up).

The transformation module 105 comprises a processor 121. In an example, processor 121 can transform or modify event data from source apparatus 103, wherein the event data can be in the form of an event or event message. In an example, the processor 121 can sort event data into fields, e.g. by parsing. A field can comprise a tuple relating to the event and/or associated with the source apparatus, and which comprises a data item, and a data identifier related to the data item. The processor 121 can update, transform or modify the data item (or a portion thereof) according to a set of rules in order to, for example, mask or pseudonymise private data, convert data fields into additional contextual information, or augment the data item with additional contextual information. The transformation module 105 operates within the trusted environment. In an example, processor 121 can be used to apply a transformation rule to a first tuple to pseudonymise a first data item in order to provide a pseudonymised data item, and/or generate a contextual supplement to the first data item.

The rule or rules can specify data fields to be removed or modified along with contextual information to be added. For example, a user's name may be removed and replaced by a GUID allowing the enterprise to re-identify the user to perform actions but keeping data private from the analytics service. At the same time additional contextualization information may be added about the user such as “administrator account”, “guest account”, “head office” or location information may be added. In some cases, the transformed/pseudonymised data item can a random token or GUID, and context (e.g. location) could be a separate untransformed label or could be concatenated with the token, etc.

In another example, the context can be used directly in the pseudonymization process. For instance, instead of substituting all user names with a token/GUID, the rules can specify to remap certain user names to be specific tokens, for example for data fields that map to non-personal and non-sensitive information—“admin” or “guest” are two such examples. In this case, user name “admin” could map to the token “admin” whereas a personal user name like “John Smith” could map to a random token, like 1E2A5 for example. Such “contextual pseudonymisation” can be thought of similarly to white listing: certain known fields will be substituted with known tokens—this can aid analytics and make certain actions more human readable and more directly actionable. In an example, information can be replaced by classes, such as “teenager”, “adult”, “guest” and so on in order to provide sufficient obscurity and the inability for a data processor to reidentify without supplemental information. In some cases, the contextualization information may be a GUID or other token so that the analytics service may know that a user was based in country x and perhaps country x is sensitive but without knowing the country.

Analytics Engine 111 can be triggered upon selected rules (based on the fields available within the event message) when event messages are fed into the system of FIG. 1 and these may build on information already stored from previous events. Alternatively, analytic rules may run regularly to derive reports. The contextual information can enable analytics to be applied that would not otherwise be used. For example, a rule may look for large numbers of events such as failed logins, or security alerts occurring at one location or being triggered from a particular source IP address (or IP addresses within a given site). Where pseudonymised tokens are used for contextual information there may be profile information available for analytics so that they can join the information into a wider group or prioritise risks.

In an example, results or output of running a rule may be a report and dashboard, or an alert that can be sent back to an enterprise for example. If the data goes into a dashboard then the enterprise user can review the source data. In either case, an enterprise analyst can de-anonymise/pseudonymise information including things like pseudonymised user tokens or pseudonymised contextual tokens. Where dashboards are created, and tokens used, these can include a link to the re-identification module 115 (running within the trusted (e.g. enterprise) boundary) which, assuming the user has permission, they could use to identify the source of the event. Where alerts are generated as a result of analytics, they can again have links to the re-identification module 115. In an example, the insights/analytics output 113 can point out key patterns and/or behaviours, in some cases pointing to the tokenized information. The authorized enterprise client could choose to conduct further investigation by using the re-identification module to re-identify the tokens and obtain the original fields, e.g. if they want to cross-correlate to their other data systems or to know who to talk to about what, etc. In an example, re-identification module 115 (in the context of anonymized data) can return not just one result but rather the whole set that applies to that particular label.

In an example, the re-identification module 115 can be used to enable analytics detecting potential security issues to be able to use the provided analytic information to track back to the originating device 103, locations or individuals—thus allowing actions. In an example, the processor 121 can generate a mapping between a pseudonymised data item and the first data item, whereby to provide a link between the pseudonymised data item and the first data item to enable subsequent resolution of the first data item using the pseudonymised data item. The mapping can be stored in transformation mapping module 123 and accessible via the re-identification module 115.

In an example, a mapping between a data item and its transformed or modified version can be in provided as a pre-generated look up table (for example, all possible user names from a client active directory are enumerated and a random ID is then assigned). Additionally, any contextual information could be used to update/adjust this table. In another example, mapping can be dynamically generated, from the data itself. For example, an initial lookup table (where any data might be whitelisted or other contextual information could be added) can be provided. Then, as new data comes in, the table can be checked to see if there is a match with the given field Fi. If so, then use the token from the table. If not, then create a new one, use this token to replace Fi, and add the data item+token as a new entry in the table. In an example, it could be a set of functions/rules that define the pseudonymization process rather than a look up table.

Accordingly, a mapping can be automatically generated (and can scale with the data). It can also handle any dynamic changes to the data (a separate table can be used per field, although one table for all fields can be used). Furthermore, it allows the process to run without intervention or access to the tables, thereby mitigating risk.

Therefore, in an example, processor 121 of the transformation module 105 can create tables containing GUIDs for personal or confidential information or can hold keys used to encrypt tokens. The re-identification module 115 can have links to this information, via module 123 for example, which can be used to store the mappings and/or tables. When an enterprise user sees an alert or information within the dashboard they can be provided with a link to the re-identification module 115. They would be able to click on the link, login using an enterprise single-sign-on for example, and assuming they have permissions to see the information, the re-identification module 115 can find the GUID in the pseudonymisation information tables and resolve the values, thereby enabling the user to see the originating event. In an example, an enterprise client (or data processor on the client's behalf/direction) can manually transform any relevant pseudonymized tokens to find out what the original field was.

According to an example, and as described above, an event message can be subdivided or parsed into a set of fields or tuples each of which is described in terms of a fieldname (data identifier) and value (data item). In the examples below, a data item is re-represented with some token. This token can be in the form of a random string/GUID. It can be in the form of a known class (e.g. “admin”,“California”) to provide context. It can also be a combination of these (e.g. a concatenation of strings that sufficiently represent context and preserve identity obfuscation across the trust boundary). The rules may apply differently depending on the fields. For example, for one field like user name, contextual pseudonymization can be applied. For another field like job name, anonymization (in the form of masking) can be applied. For a third field like source IP address, a hash function can be applied.

In an example, a rule, implemented by processor 121 for example, can have a form as follows:
When fields F1 . . . Fn are present then do one or more actions, such as from this list:
   Remove the field Fi;
   Add a field Fnew where the value is a cryptographic token based on the value, for example, E(keyx, Value) or HMAC(keyx, Value), where E is an encryption function, such as the advanced encryption standard (AES) (using e.g. an electronic codebook mode) or it could be an RSA (Rivest-Shamir-Adleman) encrypted token (without a padding scheme, such as Optimal Asymmetric Encryption Padding (OAEP)). The mode or lack of padding mean that tokens can be the same for a given value and hence can be correlated but a key is used to generate the token.
   HMAC is a cryptographic function (a hash-based message authentication code) where a message or value is hashed along with a key so the key holder can produce the mapping from value->HMAC;
   Add a field Fnew where the value is a GUID from a lookup table so that each occurrence of a given original value string (or combination of values) is replaced by a unique GUID (thus providing pseudonymization);
   Check the look up table (LUT) to see if the field has occurred before. If so, then use the string from the LUT; otherwise, generate a new random token/GUID, add field Fnew, and also add this to the mapping;
   Check a field Fi has a given format or is contained within a given lookup table or match a contextualization process. Where the check fails actions may be to encrypt the field or to log the whole message into a badly formed message log;
   Add a field Fnew where the values are converted into a range (for example: a value of 9 may be converted to ‘value between 0 and 10’).
   Add a field Fnew where the value is the result of looking up the original value (or multiple field values) in a specified context table—for example mapping IP address to an office location or mapping a user to an organization or role group;
   Add a field if Fi has a value x (or within a set of values) and Fnew is the lookup in a context table;

As described above, the transformation rules may result in a transformation mapping 123 between the data items and their transformed version. As an example, there is a “whitelisting” notion of contextual pseudonymization, where the transformation mapping 123 is in the form of one or more lookup tables. Here, they may include a pre-existing mapping to a known token (as is the case with say “admin” or the IP address of a shared server) and is used when field Fi matches this. Otherwise, a random or cryptographic token could be used, etc. This could also be used in the case of contextual anonymization: say a set of known user names or IP address are known to map to a specific class (say geography/organization) and are mapped in such a way based on field Fi. In other examples, the transformation mapping 123 could consist of a look up table or a set of rules or even generically a function(s) or some combination.

An additional rule set can be provided saying that when field (or header) fi is present check that fields I . . . p are present and potentially that each of these fields has a given form (values valid for a lookup table, match a contextualization process or match a regular expression). If the fields do not exist or have the wrong form, then the whole message can be added to a ‘badly formed message log’ and not processed further. This helps prevent badly formed messages leaking personal or confidential data. An alternative event message referring to a new message being added to the ‘badly formed message log’ may be sent to the analytics engine.

For example, a rule may say:

If message contains Source_IP address field then:
Remove Source_IP field

### Add SourceIPG=GUID_Lookup(Source_IP_Table, SourceIP)

### Add SourceIPN=Context_Lookup(Source_IP, SourceIPLocation)

This would have the effect of replacing the source ip field with two alternative fields: one with a GUID which would allow the IP address to be tracked back if an action is desired, and a second that would provide context in terms of the network infrastructure (such as the subnet and its location or whether it was associated with a VPN).

The rules themselves can be more complex. For example, they can match on two fields and add in a substitution rule when one field has a given value or where the event message has a particular header. This way more selective anonymization/pseudonymisation and contextualization strategies can be put in place.

The rules associated with the a given field can be a combination of the desires as defined in the selected analytics. Thus, for the selected analytics a rule for a given combination of fields can be generated to combine the information. Where more restrictive rules selected; for example, to capture fields in certain cases along with more permissive ones, the user may authorise which contextual data is included. This process can occur in the Analytics Selection Tool 119.

In an example, rules can be re delivered to the transformation module 105 from the analytic selection tool 119. As well as including basic rules for example, there can be references to contextualization tables. For example, “Context_Lookup(Source_IP, <SourceIP>)” which says ‘look up the SourceIP address in the context table’. This may be a table supplied by the enterprise in which case a database link and table name can be supplied. This may be a link to an enterprise system such as an active directory or configuration management database.

For example, if event data contains a user's name then this would be replaced with a GUID. But, additional contextual information can be derived from an active directory such as 107; for example, to add in a role and organizational unit. Here, additional rules can be used to specify that there may be k members of a role and to include it in the data set, or if there are less than k members of the organizational unit then an organizational unit above that in the hierarchy can be used. This means that information within the message will not be used to identify an individual and that there is a sufficient choice of individuals to provide anonymization or pseudonymisation.

Similarly, for location information, if the site that the user (or device) was associated with were to be included then sites can be aggregated into regional units where they are small. This can be done using aggregation rules that build into connectors to the systems along with the caching of information. An alternative method would be to maintain tables of the contextual data and update them as information changes in the enterprise systems.

In some cases, the contextualization may lead to the inclusion of a list of information. So, in an example, a location can be added in terms of office, site, region, country. In some cases, the contextualization data may simply lead to a Boolean (or enumerated type) in which case the information about the contextual data source can specify how to choose the type (or true or false) given the abilities of the connector. For example, a field may be created to specify if an IP address is internal or external or, if a user is involved, whether the user is an administrator for the devices being monitored (e.g. a set of printers).

Analytics can use contextualization information in order to correlate events and look for common targets or common sources of problems. For example, an analytic may know the IP addresses associated with a particular office, but not the office location, x. Hence contextualization information can itself be expressed in terms of pseudonymization tokens or GUIDs which enable correlation but not identification. Following this strategy along with a GUID for the contextualization information additional information can be shared with the analytics engine 111; for example, that certain office GUIDs are all within a region GUID or risk information to suggest we are more worried about attacks from or to a particular set of GUIDs. Such information can be re-identified when passed back to the enterprise users thus allowing actions.

In an example, an analytics service can be used to monitor multiple companies. Alternatively, a company may use different privacy rules for different groups of devices; for example, where they are within different countries with different privacy regulations or where parts of the business differ significantly.

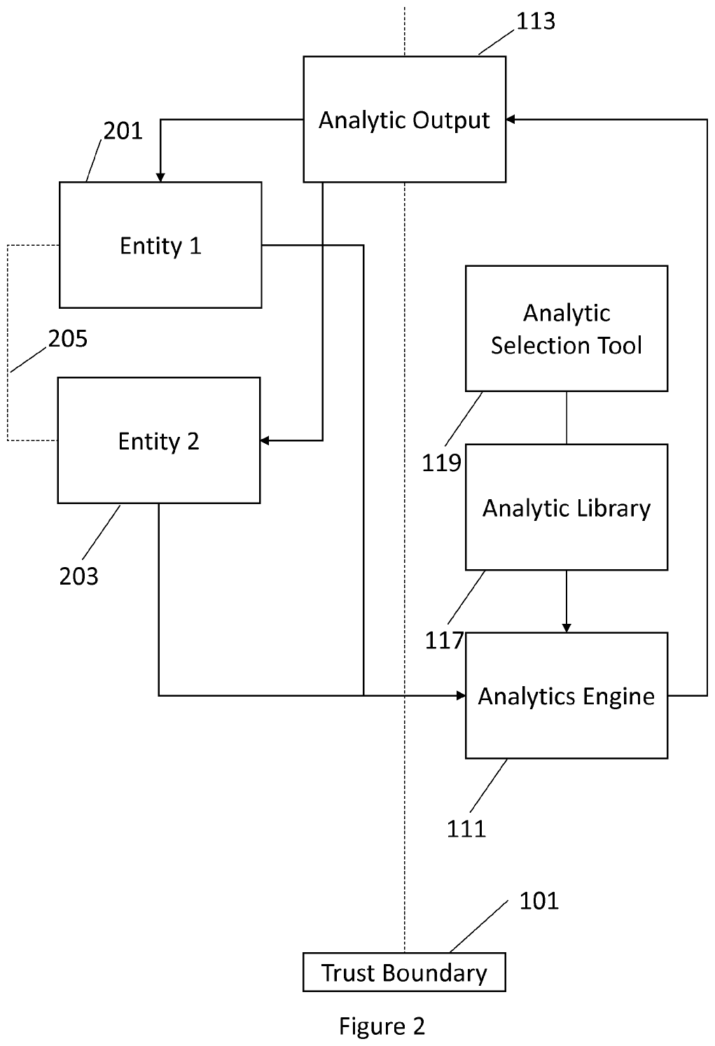

FIG. 2 is a schematic representation of a system according to an example. The example of FIG. 2 depicts application to multiple domains. That is, there may be a situation where a service is managing:
Multiple companies;
Systems within a company where different privacy jurisdictions have different transformation (anonymization, pseudonymization, and contextualization) rules to apply.

In the first case each company (e.g. entity 1, 201, and entity 2, 203) can select their own analytic rules and hence anonymization, pseudonymisation and contextualization rules. Each company can have their own domain including the collection, transformation and re-identification systems and so on as described with reference to FIG. 1. A portal can be provided such that each company can get access to their company information and alerts. Each entity 201, 203 can refer to the re-identification service within each enterprises trust domain. In an example, each entity 201, 203 can synchronise (205) information such as contextual information for example. In such a case, another trust boundary may be defined between entity 1 and entity 2. When multiple entities are being managed by the same security service the transformation module may have an additional rule that adds an entity identifier into the event messages to identify the location it comes from.

In the second case, a company may segment devices into groups according to organizational or geographic boundaries (e.g. US vs EU where rules may be very different). Here a company may choose different analytics and hence transformation rules to fit in with the local privacy laws and regulations. Thus, the device groupings (and hence boundaries) can be defined within the analytics selection tool and the associated anonymization and/or pseudonymisation rules pushed out to the appropriate geographic transformation processors. Thus, depending on the source of the events different rules may apply and different lookup tables may be created. Within this context people and devices can be mobile and so an additional process to synchronise or exchange information between the lookup tables can be provided. A strategy to use contextualization information to specify which look up table pseudonymization tokens exist in can be used and can allow the look up from other domains. In an example, by default, there may be no synchronization 205 across entities, with each being processed independently. This may be due to varying country/regional data privacy regulations as well as potential corporate policies. The result is that the data/insights may fragmented. For instance, a user that happens to conduct business in both entities will likely be mapped to distinct tokens, and thus the resulting insights will remain distinct. If synchronization is permitted and conducted, then this information could be linked and higher fidelity insights and results could be achieved. In an example, a module can be provided that can provide such synchronization mapping across the trust boundary to help improve the analytics engine.

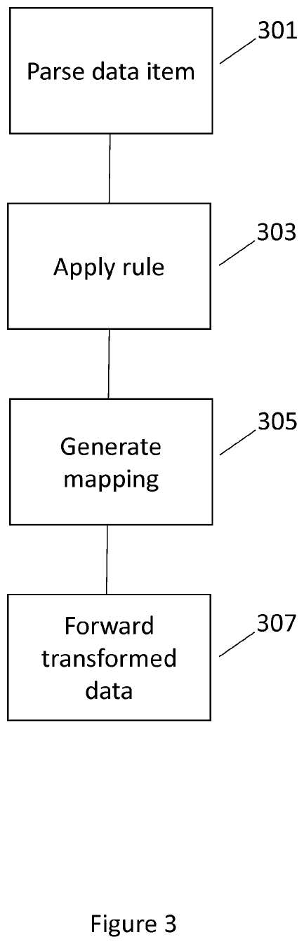

FIG. 3 is a flowchart of a method for modifying a data item from a source apparatus, the data item associated with an event, according to an example. In block 301, a data item originating from a source apparatus within a trusted environment is parsed to generate a set of tuples relating to the event and/or associated with the source apparatus, each tuple comprising a data item, and a data identifier related to the data item. In block 303, a rule is applied to a first tuple to transform a first data item, such as to provide a pseudonymised data item, and/or generate a contextual supplement to the first data item. In block 305, a mapping between the transformed data item and the first data item is generated, whereby to provide a link between the transformed data item and the first data item to enable subsequent resolution of the first data item using the transformed data item. In an example, a mapping can also be between a data item and its (e.g. anonymized/pseudonymised) token. The resulting mapping here is a many to one, so reidentification would be down to a set of individuals rather than a specific individual. For completeness, the mapping between a data item and its token is a one-to-one mapping, and so reidentification would result in a specific match

In block 307, the transformed data item and the data identifier related to the first data item are forwarded to an analytics engine situated logically outside of the trusted environment.

Therefore, according to an example, there is provided a method to manage how messages are anonymised and/or pseudonymised and how additional contextual information is added based on a set of analytics that a client is interested in. Extra contextual information enables more advanced and more effective security monitoring and analytics such as correlating events aimed from or to different locations or against particular parts of the business whilst preserving privacy. The configurability enables the same security analytics system/service (architecture and engine) to be offered to a variety of clients with differing privacy desires and priorities.

Examples in the present disclosure can be provided as methods, systems or machine-readable instructions, such as any combination of instructions, hardware, firmware or the like. Such machine-readable instructions may be included on a computer readable storage medium (including but not limited to solid state storage, disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realised by machine readable instructions.

The machine-readable instructions may, for example, be executed by a general-purpose computer, a special purpose computer, an embedded processor or processors of other programmable data processing devices to realise the functions described in the description and diagrams. In particular, a processor or processing apparatus may execute the machine-readable instructions. Thus, modules of apparatus (for example, transformation module 105, analytics engine 111) may be implemented by a processor (e.g. 121) executing machine readable instructions stored in a memory, or a processor operating in accordance with instructions embedded in logic circuitry. In an example, such modules may be implemented in a cloud-based infrastructure, across multiple containers such as virtual machines or other such execution environments instantiated over physical hardware. The term ‘processor’ is to be interpreted broadly to include a CPU, processing unit, ASIC, logic unit, or programmable gate set etc. The methods and modules may all be performed by a processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

With reference to FIG. 1 for example, processor 121 can be associated with a memory 152. The memory 152 can comprise computer readable instructions 154 which are executable by the processor 121. The instructions 154 can comprise instructions to: analyse data associated with an event from a originating apparatus; modify at least a portion of the data, whereby to pseudonymise and/or add contextual information to the data on the basis of one or more rules to provide modified event data; generate an association between the data from the originating apparatus and the modified event data to enable resolution of the data within a trusted environment using the modified event data; and interpret the modified event data using one or more analytics rules to determine the presence of a correlation between multiple events.

Such machine readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made. Furthermore, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for modifying a data item from a source apparatus, the data item associated with an event, the method comprising:
within a trusted environment, parsing the data item to generate a set of tuples relating to the event and/or associated with the source apparatus, each tuple comprising a data item, and a data identifier related to the data item;
applying a rule to a first tuple to transform a first data item to provide a transformed data item, and/or generate a contextual supplement to the first data item;
generating a mapping between the transformed data item and the first data item, whereby to provide a link between the transformed data item and the first data item to enable subsequent resolution of the first data item using the transformed data item; and
forwarding the transformed data item and the data identifier related to the first data item to an analytics engine situated logically outside of the trusted environment.

2. The method as claimed in claim 1, wherein a contextual supplement to the first data item includes a Globally Unique Identifier (GUID), and/or data representing one or more of a physical location of the source apparatus, a network location of or identifier associated with the source apparatus, information relating to a user of the source apparatus.

3. The method as claimed in claim 1, wherein the first data item is transformed on the basis of an outcome of the application of the rule to the first tuple.

4. The method as claimed in claim 1, wherein the mapping is generated dynamically.

5. The method as claimed in claim 1, wherein the contextual supplement to the first data item is a pseudonymization token or GUID configured to enable correlation between multiple events.

6. The method as claimed in claim 1, further comprising:
segmenting the source apparatus according to trust boundary, organisational and/or geographic boundary.

7. The method as claimed in claim 6, wherein the rule is selected according to a set of criteria relating to the segmentation.

8. A system for modifying a data item from a source apparatus, the system comprising:
a transformation module comprising a processor to: receive the data item and transform at least a portion of the data item according to one or more instructions defining information to be modified, and/or augment the data item with contextual data to provide a transformed data item; and generate a relationship between the transformed data item and the data item;
the system further comprising an analytics engine located logically outside of a boundary associated with a trusted environment within which the source apparatus is located to:
inspect the transformed data item.

9. The system as claimed in claim 8, the analytics engine further to:
apply an analytics rule to the transformed data item.

10. The system as claimed in claim 9, the analytics engine further to:
generate an alert on the basis of an outcome of the application of the analytics rule to the transformed data item.

11. The system as claimed in claim 8, further comprising:
an analytics library located logically outside of the boundary to store multiple analytics rules for use by the analytics engine.

12. The system as claimed in claim 8, wherein the transformation module is located logically within the boundary.

13. A non-transitory machine-readable storage medium encoded with instructions executable by a processor, the machine-readable storage medium comprising instructions to:
analyse data associated with an event from an originating apparatus;
modify at least a portion of the data, whereby to pseudonymise and/or add contextual information to the data on the basis of a rule to provide modified event data;
generate an association between the data from the originating apparatus and the modified event data to enable resolution of the data within a trusted environment using the modified event data; and
interpret the modified event data using an analytics rule to determine the presence of a correlation between multiple events.

14. The non-transitory machine-readable storage medium of claim 13, further encoded with instructions executable by the processor to:
use historical data to determine the presence of a correlation between multiple events.

15. The non-transitory machine-readable storage medium of claim 13, further encoded with instructions executable by the processor to:
receive a set of choices representing desired analytics; and
generate a set of contextualization and pseudonymization rules based on the set of choices.
